(19) United States
(12) Patent Application Publication
(10) Pub. No.: US 2023/0130021 A1
(43) Pub. Date: Apr. 27, 2023

(54) PRIVACY-PRESERVING MACHINE LEARNING MODEL IMPLEMENTATIONS

(71) Applicant: Google LLC, Mountain View, CA (US)

(72) Inventors: Wittawat Jitkrittum, Atlanta, GA (US); Michal Mateusz Lukasik, New York, NY (US); Ananda Theertha Suresh, New York, NY (US); Xinnan Yu, New York, NY (US); Gang Wang, Frederick, MD (US)

(21) Appl. No.: 17/974,334

(22) Filed: Oct. 26, 2022

Related U.S. Application Data
(60) Provisional application No. 63/272,339, filed on Oct. 27, 2021.

(51) Int. Cl. G06N 3/08; H04L 9/40; G06N 3/04

(52) U.S. Cl. CPC G06N 3/08; H04L 63/0428; G06N 3/0481

(57) ABSTRACT

Methods, systems, and apparatus, including computer programs encoded on a computer storage medium, for implementing privacy-preserving machine learning models (e.g., neural networks) in secure multi-part computing environments. Methods can include computing an output of a particular layer of a neural network deployed in a two computing system environment using a cosine activation function.

### CROSS-REFERENCE TO RELATED APPLICATIONS

This application claims the benefit under 35 U.S.C. § 119(e) of U.S. Patent Application No. 63/272,339, entitled “Efficient Neural Architectures for Secure Multi-Party Computation,” filed Oct. 27, 2021. The disclosure of the foregoing application is incorporated herein by reference in its entirety for all purposes.

### TECHNICAL FIELD

This specification relates to machine learning models and in particular, relates to privacy-preserving machine learning model implementations in secure multi-part computing environments.

### BACKGROUND

Machine learning models receive an input and generate an output, e.g., a predicted output, based on the received input. Neural networks are a type of machine learning model that generally multiple layers (also referred to as neural network layers) to generate an output, e.g., a classification, for a received input. Some neural networks include one or more hidden layers in addition to an input and an output layer. The output of each hidden layer is used as an input to the next/successive layer, i.e., the next hidden layer or the output layer of the network. Each layer of the neural network generates an output from the received input in accordance with current values of a respective set of parameters.

Generally, one or more nodes in a neural network layer receives an input from node(s) in a preceding layer and produces an activation from the received inputs in accordance with a set of weights for the nodes/layer. The activations generated are provided as an input to one or more node(s) in the next neural network layer (or to the output layer if the given layer is the last layer in the network).

To generate these activations or outputs, the neural network utilizes an activation function that defines how the weighted sum of an input is transformed into an output from a node or nodes in a layer of the network. Examples of activation functions include Sigmoid/logistic function, Tanh function, ReLU or Leaky ReLU functions. In some neural networks involving fully-connected neural network layers, an activation is generated for a particular node in a given layer from the received inputs at the node and in accordance with a set of weights for the node. The activations generated by each node in a given fully-connected layer are then provided as input to each node in the next fully-connected layer of the neural network. For neural networks involving convolutions layers (which are generally sparsely connected layers), each node in a given convolutional layer receives an input from a portion of (i.e., less than all of) the nodes in a preceding layer and an activation is generated by convolving received inputs in accordance with a set of weights for the nodes in the given layer.

Training and inferring machine learning models (such as neural networks) can be performed in a secure multi-party computing (MPC) environment that prevents collection of training data (used for training) or feature data (used for inference) at a single entity (e.g., a centralized server), by distributing the requisite model computations across multiple entities (e.g., multiple servers). This in turn results in no particular entity involved in the MPC environment having access to another entity's data or intermediate computed values, while ensuring that outputs are released only to designated entities. The MPC computing systems typically perform the computations using secret shares or other encrypted forms of the data and secure exchange of information between these systems/entities.

### SUMMARY

In general, one innovative aspect of the subject matter described in this specification can be embodied in methods for computing an output of a particular layer of a neural network deployed in a two computing system environment using a cosine activation function, where the output is computed for input data that is split into a first data part and a second data part, with the first data part being provided to a first computing system and a second part being provided to a second computing system. In such implementations, the methods include operations, as implemented by a first computing system, of generating, based on the first data part, a cosine value and a sine value; generating, for each of the cosine value and the sine value, a pair of additive secret shares; transmitting, to the second computing system, a first secret share from each pair of the additive secret shares; receiving, from the second computing system, a pair of secret shares that are generated by the second computing system using the second data part; multiplying, using a secure multiplication protocol and in collaboration with the second computing system, (1) the pair of additive secret shares corresponding to the cosine value with a second pair of secret share cosine values, to obtain a first cosine product and a second cosine product, and (2) the pair of additive secret shares corresponding to the cosine value with a second pair of secret share sine values, to obtain a first sine product value and a second sine product value, wherein the second pair of secret share cosine values and the second pair of secret share sines values are computed by the second computing system; computing a first part of a cosine activation value based on the first cosine product and the first sine product; and providing the first part of the cosine activation value for further processing by another layer of the neural network or to a third computing device for computation of an overall output of the neural network.

Other implementations of this aspect include corresponding apparatus, systems, and computer programs, configured to perform the aspects of the methods, encoded on computer storage devices. These and other implementations can each optionally include one or more of the following features.

In some implementations, generating, for each of the cosine value and the sine value, the pair of additive secret shares, can include generating, using the cosine value, a first pair of secret share cosine values; and generating, using the sine value, a second pair of secret share sine values.

In some implementations, transmitting, to the second computing system, the first secret share from each pair of the additive secret shares, can include transmitting, to the second computing system, a first secret share sine value selected from the first pair of secret share sine values; and transmitting, to the second computing system, a first secret share cosine value selected from the first pair of secret share cosine values.

In some implementations, the secure multiplication protocol can be a Beaver Triplets protocol.

In some implementations, the method can further include storing the first cosine product value and the first sine product value in a repository corresponding to the first computing system.

In some implementations, computing the cosine activation can be performed during training of the neural network and wherein the input data is training data for training the neural network, the first data part is a first part of the training data, and the second data part is a second part of the training data.

In some implementations, providing the first part of the cosine activation value for further processing by another layer of the neural network or to the third computing device for computation of the overall output of the neural network can include when the particular layer is not an output layer of the neural network, providing the first part of the cosine activation value as input to a subsequent layer in the neural network; or when the particular layer is the output layer of the neural network, providing the first part of the cosine activation value to the third computing device for computation of the overall output of the neural network.

In some implementations, the pair of secret shares that are generated by the second computing system using the second data part can include a third secret share sine value and third secret share cosine value.

In some implementations, computing the first part of the cosine activation value can include structuring a weigh matrix using Hadamard-Diagonal matrices, where the Hadamard-Diagonal matrices can include diagonal matrices with learnable weights and a normalized Walsh-Hadamard matrix of a predefined order.

In some implementations, structuring the weight matrix using the Hadamard-Diagonal matrices can include multiplying the diagonal matrices with learnable weights, with the normalized Walsh-Hadamard matrix.

In some implementations, the diagonal matrices with learnable weights are represented as D∈R^{d*d} and the normalized Walsh-Hadamard matrix (H) has a predefined order of d and is defined recursively using the following equation (where k=d):

$${H}_{{2}^{k}} = \frac{1}{{2}^{k / 2}} [ \begin{matrix}{H}_{{2}^{k - 1}} & {H}_{{2}^{k - 1}} \\ {H}_{{2}^{k - 1}} & - {H}_{{2}^{k - 1}}\end{matrix} ]$$

Particular embodiments of the subject matter described in this specification can be implemented to realize one or more of the following advantages. For example, the subject matter described herein enables training and inference of machine learning models (e.g., neural networks) deployed in a multi-party computation (MPC) setup that is more efficient in terms of computational and network resources. In MPC implementations for machine learning model operations (e.g., those related to training and inference), the computation cost stemming from the communications required to facilitate the requisite operations between the entities/computing systems involved in the communication, generally involves three factors: (1) the number of rounds of communications, or in other words, the number times that parties (also referred to herein as entities) in the MPC setup communicate/synchronize with each other to complete the MPC crypto protocol (e.g., for a two-party computation (2PC) setup, this is equivalent to the number of Remote Procedure Calls (or RPCs) that the two parties need per the crypto protocol design); (2) the number of bytes that the parties in the MPC setup need to send (as RPC) to each other to complete the MPC crypto-protocol (e.g., for 2PC, each RPC between two parties has a request and a response, and associated bytes of data); and (3) a latency of the network that is used to facilitate communication between the entities/parties in the MPC setup.

In some conventional MPC environments/setups, the number of rounds of communications to compute a L-layer neural network generally involves L rounds of communications between the communicating entities/parties in the MPC cluster, which can be resource intensive and can require computation of non-linear activations at one party (in the MPC cluster) in a manner that results in intermediate results being leaked to that party (and thus, undermines the goal of MPC setups in the context of model training and inference, which seeks to avoid either party from learning the data possessed by the other party and vice-versa).

In contrast, the techniques described herein perform the requisite neural network training and inference operations using a cosine activation function in the MPC setup in a manner (and as described throughout this specification) that achieves significant communication/network resource efficiencies by using fewer rounds of communications, e.g., two online rounds of communication (relative to conventional MPC setups that require multiple additional communication rounds and as a consequence, relatively more computational and network resources).

Further still, the techniques described herein enable training and inference operations to be performed by entities/computing systems in an MPC/2PC environment, without leaking or revealing any of the original input data to either of the entities involved in the MPC/2PC environment. In doing so, the techniques described in this document can enable operation of neural network operations in a privacy preserving manner while achieving the above-described significant resource (computing and network) efficiencies relative to other MPC-based systems.

Moreover, the communication and network resource efficiencies achieved by the techniques described herein also stem, at least in part, from the replacement of dense and unstructured matrices in the implemented neural networks with structured matrices that have comparable performance to existing neural network architectures and can be efficiently implemented in MPC setup in manner that reduces the bandwidth consumption/needs. Indeed, by using structured matrices, such as Hadamard-Diagonal matrices, the number of per-layer secure multiplications can be reduced from O(d²) to O(d)—where d is the layer width—thus reducing the memory bandwidth needed.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a secure multi-party computation (MPC) cluster of servers is used to facilitate operations of machine learning models in a data privacy-preserving manner.

FIG. 2 is a flow diagram of an example process for computing an output of a neural network layer in an MPC environment that preserves privacy over the input data used in the neural network computations.

FIG. 3 is a block diagram of an example computer system that can be used to perform operations described.

### DETAILED DESCRIPTION

This document discloses methods, systems, apparatus, and computer readable media that are used to implement techniques for privacy-preserving machine learning model implementations in secure multi-party computing environments.

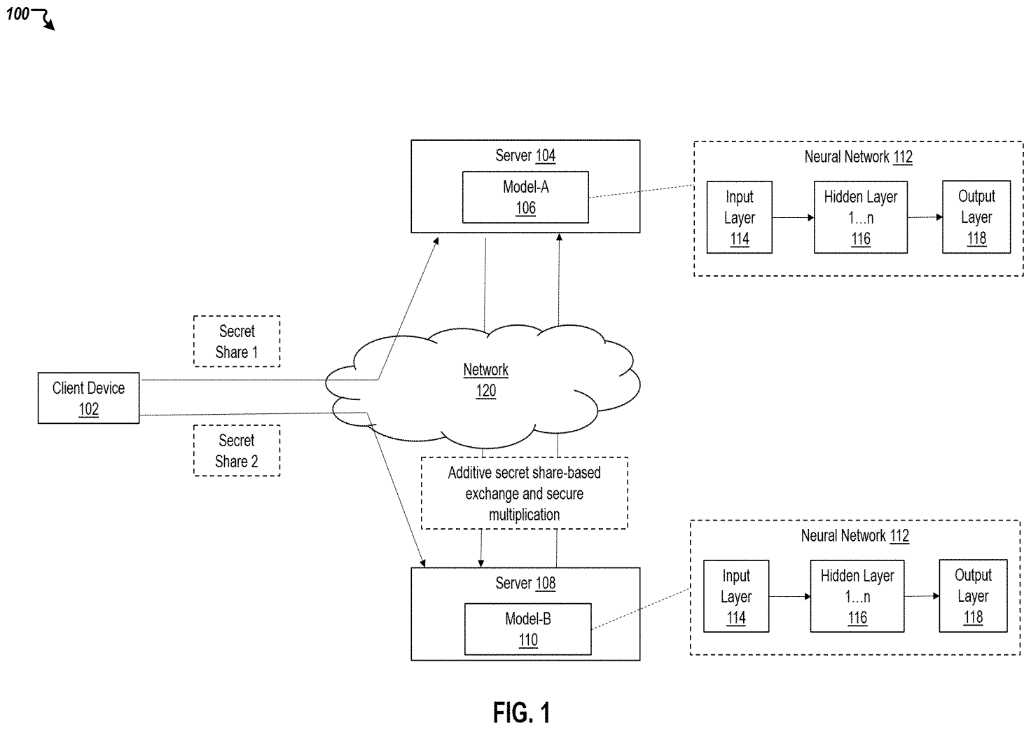

As summarized below, and as further described with reference to FIGS. 1-3, the techniques described in this specification contemplate a multi-party computing environment, such as a two-party computing (2PC) environment/cluster, in which neural network training and inference operations are performed in a privacy preserving manner using two (or more) non-colluding computing systems/servers that each deploy a neural network made up of multiple layers. In such an environment, a third computing system can provide secret shares of input data (e.g., training data for training or feature data for inference operations) to each computing system in the 2PC cluster. Using its respective share of the input data, each computing system in the 2PC cluster can compute a share of a cosine activation value for a particular layer of its respective neural network. This computation includes performing local computations (i.e., computations performed at that particular computing system), including generating a cosine and sine value for the received secret share, and further generating pairs of secret additive shares based on these cosine and sine values.

Each computing system in the 2PC cluster then performs two online rounds of communication, one for exchanging a portion of its secret additive shares with the other computing system and another for performing a secure multiplication in collaboration with the other computing to generate sine and cosine product values using each party/computing system's additive shares corresponding to their respective cosine and sine values. The respective sine and cosine product values of each computing system are then used to compute respective shares of the cosine activation value. These shares of the cosine activation value can serve as inputs for a successive layer of the neural network, and the above described operations can thus be iteratively performed for each layer of the neural network (i.e., from the input layer to the output layer, with the computed output for each layer serving as the input for the successive layer in the neural network). Upon performing the above-described operations for the output later, the output shares of the cosine activation values computed by each computing system can be transmitted to the third computing device, which in turn can combine these shares of the cosine activation value to determine the overall network output of the neural network.

Moreover, as part of the above-summarized cosine activation computations, a series of linear transformation operations (e.g., multiplication of a weight matrix with the received share of the input data) are performed. In some implementations, the weight matrix can be structured using Hadamard-Diagonal matrices.

These and additional aspects and operations are described below with reference to FIGS. 1-3.

FIG. 1 is an example block diagram of an environment 100 in which a secure multi-party computation (MPC) cluster of servers is used to facilitate operations of machine learning models in a data privacy-preserving manner.

The example environment 100 includes a network 120, such as a local area network (LAN), a wide area network (WAN), the Internet, or a combination thereof. The network 120 connects client devices 102 and multiple servers, such as server 104 and server 108, which can be servers that are part of a cluster of servers (also referred to as a 2PC or MPC cluster).

A client device 102 is an electronic device that is capable of requesting and receiving resources over the network 120. Example client devices 102 include personal computers, mobile communication devices, wearable devices, personal digital assistants, gaming systems, virtual reality systems, streaming media devices, and other devices that can send and receive data over the network 120. A client device 102 typically includes one or more applications, such as a web browser, to facilitate the sending and receiving of data over the network 120, but native applications executed by the client device 102 can facilitate the sending and receiving of data over the network 120 as well.

As shown in FIG. 1, each of servers 104 and 108 includes a portion of a machine learning model, namely, machine learning model 106 (also referred to herein as model A) and machine learning model 110 (also referred to herein as model B). As described previously, each machine learning model 106 and 110 can be implemented as an identical neural network (such as network 112), which includes the same number of layers, including an input layer 114, one or more hidden layers 116, and an output layer 118. The servers 104 and 108 make up what is referred to herein as a multi-party computing (MPC) or a two-party computing (2PC) cluster.

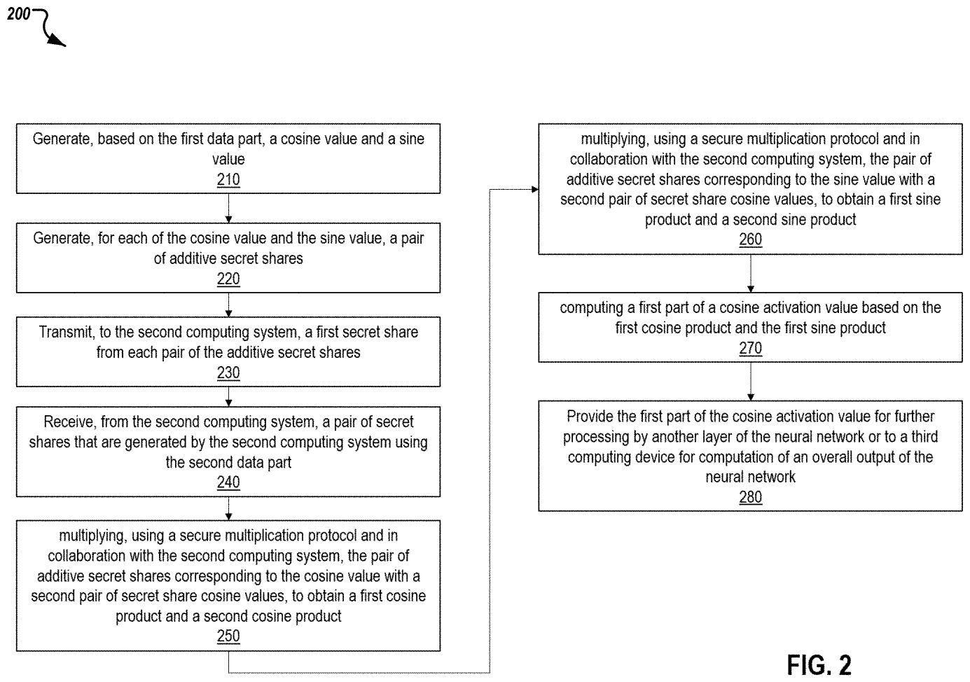

As described below and as further described with reference to FIG. 2, each of the servers in the MPC (i.e., each of servers 104 and 108) has a portion of the machine learning model (i.e., the model A and model B, which are also individually referred to herein as sub-models) and each collaborates and operates on data received in the form of secret shares (at input and in each intermediate computation) to train their respective sub-models and to perform prediction/inference operations using the trained sub-models. Although FIG. 1 only depicts two servers as part of a MPC cluster, one skilled in the art will appreciate that any number of servers can be deployed as part of the MPC cluster (and by extension, any number of submodels implemented by each such server). For ease of description and conciseness, the following description describes the MPC-based model training and inference operations in the context of a two-party computation (2PC) setup (however, it will be understood that the same techniques described below are also applicable in the context of MPC setups involving more than two parties/entities/servers, e.g., three servers, four servers, etc.).

During model training in the 2PC setup, each party (i.e., each of server 104 and server 108) receives features and labels of the training dataset in the form of secret shares. Note that each share by itself can be a random variable that by itself does not reveal anything about the training sample. Both secret shares would need to be combined to get the training sample. If the MPC cluster includes more computing systems/servers that participate in the training of a machine learning model, more shares would be generated, one for each computing system/server. In some implementations, to protect data privacy, a pseudorandom function can be used to split the training sample into shares. The exact splitting can depend on the secret sharing algorithm and crypto library used by the application.

Moreover, each of servers 104 and 108 stores a portion of the overall machine learning model (represented in FIG. 1 as model A and model B), and each such sub-model can be implemented as an identical neural network 112 (with an identical number of layers). During training of each sub-model, each respective server 104/108 processes the input training data through the neural network layers, with all intermediate results and the final output of the network being stored and maintained in the form of secret shares. In this manner, during training, both servers 104 and 108 collaboratively learn a machine learning model, which is split between two parties.

Upon completion of the training, the final result, i.e., the machine learning model itself, which is made up of the trained parameters, are in secret shares held by each party (i.e., each of servers 104 and 108) in the 2PC setup. In other words, after training, the trained parameters of the machine learning model are stored/maintained at different servers such that neither server has access to the entire set of trained model parameters, which in turn enables data privacy over the model parameters as well.

After training, and during inference/prediction, each server/party receives input features in secret shares from, e.g., a client device 102, and processes the secret shares using the trained parameters and through the neural network layers, with all intermediate results and the final output of the respective submodel being stored and maintained in the form of secret shares. Each of servers 104 and 108 then sends the prediction results output by its respective submodel in secret shares back to the client device 102 that provided the input features for prediction. The client device 102 can combine all shares of the secret prediction results into a plaintext representation to discern the overall model output. In this manner, and through the training and prediction processes, neither server in the MPC cluster learns or becomes privy to any of the input training or feature data, as well as the trained parameter data making up the overall machine learning model.

Relatedly, one skilled in the art will appreciate that the two servers are non-colluding servers such that each server does not have access to or is not privy to the data received by any other server in the 2PC/MPC cluster. In this manner, neither server has access to the complete input data or the overall trained parameters of the machine learning model in plaintext. As used in this document, plaintext refer to text that is not computationally tagged, specially formatted, or written in code, or data, including binary files, and which is in a form that can be viewed or used without requiring a key or other decryption device, or other decryption process. In some implementations, each of the servers 104 and 108 can be controlled and managed by different trusted entities and/or are separated architecturally (and do not otherwise communicate with each other that to perform the techniques described in this document).

As described above, an activation function is generally used to compute the output of each neural network layer. As described below, in the 2PC setup (and in the broader context of MPC setups contemplated herein), a cosine activation can be utilized to compute the output for a particular layer of the neural network corresponding to each submodel (i.e., model A 106 and model B 110).

In some implementations, the cosine activation function of the neural network can be represented using the following equation:

cos(Wx+b)

where x∈R^{d} is the input (which in the context of the MPC setup, would be the secret share of the input data), W∈R^{k*d} is the neural network parameter matrix (also referred to herein as the weight matrix), and b∈R^{k} is a bias vector.

As depicted in the above equation, linear transformation operations are performed to compute the product of the weight matrix and the input data (Wx). Such operations can be resource intensive given the ∂(dk) multiplications that have to be performed for these operations. Moreover, because in an MPC/2PC setup, the weight matrix and the input data are encrypted, the bandwidth required for computing their product is proportional to O(dk). To reduce the bandwidth and resource intensive nature of these linear transformation operations, a specific structure based on the Hadamard-Diagonal matrix can be imposed on the structure of the weight matrix. In some implementations, this can represented using the following equation:

W=HD

where D∈R^{d*d} is a diagonal matrix with learnable weights and H is the normalized Walsh-Hadamard matrix of order d with the following recursive definition (where it is assumed that k=d):

$${H}_{{2}^{k}} = \frac{1}{{2}^{k / 2}} [ \begin{matrix}{H}_{{2}^{k - 1}} & {H}_{{2}^{k - 1}} \\ {H}_{{2}^{k - 1}} & - {H}_{{2}^{k - 1}}\end{matrix} ]$$

When using the Hadamard-Diagonal matrix structure for the linear transformations, the mapping y=cos(Wx) provides lower approximation error of a shift-invariant kernel relative to random unstructured matrices. Indeed, by pairing a cosine-based function (as described above and further described below) with the Hadamard-Diagonal structure, even at initialization, the feature space mimics the feature space of a kernel and by optimizing the weights of the diagonal matrices, the model implicitly learns a good shift invariant kernel for the task. In summary, the structure imposed on the weight matrix via the Hadamard-Diagonal matrix reduces the computational resource cost of the linear transformation operations (relative to transformations performed using unstructured or randomly structured weight matrices) while preserving the quality and accuracy of the model output.

The following description now provides an example implementation of the cosine activation in context of a 2PC/MPC setup. In some implementations, to compute the output of a layer of the neural network using the cosine activation function (e.g., during the training and/or the prediction phases), each of the servers 104 and 108 of the 2PC/MPC cluster can compute the sine and cosine of their respective secret shares (received as input [x], e.g., from a different computing device, such as client device 102). For example, assume that server 104 has access to the first share of input features [x]₁ of the set of features [x] and server 108 has access to the second share of input features [x]₂ such that [x]₁+[x]₂=[x]. Using the share [x]₁, server 104 can compute cos[x]₁ and sin[x]₁, and similarly, server 108 can compute cos[x]₂ and sin[x]₂ using its share [x]₂.

In some implementations, each of the servers 104 and 108 can generate additive secret shares based on the sine and cosine values of their respective secret shares. For example, server 104 can use an additive secret share algorithm to generate, from cos[x]₁, [cos[x]₁]₁ and [cos[x]₁]₂, and generate, from sin[x]₁, [sin[x]₁]₁ and [sin[x]₁]₂. Similarly, and in parallel, server 108 generates, from cos[x]₂ and sin[x]₂, [cos[x]₂]₁, [cos[x]₂]₂, [sin[x]₂]₁ and [sin[x]₂]₂.

In some implementations, each of the servers 104 and 108 can transmit to the other server a portion of its respective additive shares while retaining another portion of the additive shares to enable a subsequent secure multiple computation described below. For example, server 104 can transmit [cos[x]₁]₂ and [sin[x]₁]₂ to server 108. Similarly, server 108 can transmit [cos[x]₂]₁ and [sin[x]₂]₁ to server 104.

In some implementations, each of the servers 104 and 108 can use a secure multiplication protocol, such as, e.g., Beaver Triplets, to collaboratively compute a secure multiplication of both servers' cosine additive shares as well as a secure multiplication of both servers' sine additive shares. The resulting secure multiplication operations can be represented using the following equations (where Mutt refers, in this implementation, to the Beaver Triplets secure multiplication protocol):

[cos[x]₁ cos[x]₂]₁,[cos[x]₁ cos[x]₂]₂=Mult(([cos[x]₁]₁,[cos[x]₂]₁),([cos[x]₁]₂,[cos[x]₂]₂)

and

[sin[x]₁ sin[x]₂]₁,[sin[x]₁ sin[x]₂]₂=Mult(([sin[x]₁]₁,[sin[x]₂]₁),([sin[x]₁]₂,[sin[x]₂]₂)

In some implementations, server 104 can store the first cosine product value and the first sine product value in a repository corresponding to the server 104. In some implementations, and upon completion of the secure multiplication (as described in the preceding operation 260), server 104 stores the following cosine and sine product values (generated as part of the secure multiplication) in a repository or other data storage devices accessible to the server 104: ([cos[x]₁]₁, [cos[x]₂]₁) and ([sin[x]₁]₁, [sin[x]₂]₁). Similarly, server 108 stores the following second cosine and second sine product values (generated as part of the secure multiplication) in a repository or other data storage devices accessible to the server 108: ([cos[x]₁]₂, [cos[x]₂]₂) and ([sin[x]₁]₂, [sin[x]₂]₂).

In some implementations, each of the servers 104 and 108 generates its share of the output of the activation function, e.g., based on the above-determined sine and cosine product values (as determined using the secure multiplication). For example, server 104 can compute its share of the output [Z]₁, which can be represented using the following equation:

[Z]₁=[cos[x]₁ cos[x]₂]₁−[sin[x]₁ sin[x]₂]₁

Similarly, server 108 can compute its share of the output [Z]₂, which can be represented using the following equation:

[Z]₂=[cos[x]₁ cos[x]₂]₂−[sin[x]₁ sin[x]₂]₂

In the above equations, [Z]₁ and [Z]₂ are shares of the output of the activation function of a particular layer of each submodel 106 and 110, such that overall output of the activation function for the particular neural network layer is [Z]=[Z]₁+[Z]₂, which can be represented using the following equation:

[Z]=cos[x]₁ cos[x]₂−sin[x]₁ sin[x]₂

Because one skilled in the art will appreciate that the cosine of the sum of two variables a and b (which would be reflected as cos(a+b)) equals cos(a)*cos(b)−sin(a)*sin(b), by trigonometric identity, the above equation of [Z] equates to cos([x]₁+[x]₂), which in turn equates to cos(x). In this manner, the overall cosine activation output for the layer can be computed using the cosine activation function, by combining the respective outputs of each of the submodels 106 and 110 of the servers 104 and 108, respectively.

One skilled in the art will also appreciate that, in the context of a neural network including multiple layers, the above-described computation of the shares of the cosine activation output for one layer serves as an input to a subsequent layer of the neural network 112 maintained by each of server 104 and server 108. For example, the share of the cosine activation output generated with respect to one layer of the neural network 112 (corresponding to submodel 106) is provided as an input to a next/successive layer in the neural network 112, and similarly, the share of the cosine activation output generated with respect to one layer of the neural network 112 (corresponding to submodel 110) is provided as an input to a next/successive layer in the neural network 112. And then, the above-described cosine activation computations (including the local computation of the sine and cosine values, the additive shares generation, the exchange of some of the additive shares, and the secure multiplication) are repeated at both servers 104 and 108 until the respective shares of the cosine activation output are generated. In this manner, the above-described operations are iteratively performed, by each of the servers 104 and 108, and for each of the layers—i.e., the input layer, the hidden layer(s), and the output layer—of their respective neural networks 112 (corresponding to submodels 106 and 110, respectively).

After the processing inputs of each output layer of the submodels 106 and 110 results in the respective share of the cosine activation output, each of the servers 104 and 108 can provide its respective output shares ([Z]₁ and [Z]₂), to the client device 102. The client device 102 can then compute the overall output of the neural network by combining the output shares received from each server, and the overall output of the neural network can then be computed using the following equation (as previously reproduced and described above):

[Z]=cos[x]₁ cos[x]₂−sin[x]₁ sin[x]₂

As illustrated by the above description, the above-described operations for computing the cosine activation in the MPC/2PC setup contemplates two rounds of online communication (and associated bandwidth and network and communication resources) between the servers in the MPC/2PC cluster: one round for the exchange of the additive share values and another round for performing the secure multiplication, e.g., using the Beaver Triplets protocol. Note that the other operations—relating to generating sine and cosine values for each secret share, additive share generation of these secret shares, and the final computation of the share of the cosine activation—are locally performed by each server and thus, do not require any network bandwidth or associated communication/network resources. By limiting the number of rounds of communication (and the associated data exchanged in those communications) to two, the above-described operations achieve significant communication and network resource efficiencies relative to other activation functions deployed in 2PC/MPC setups that require relatively more rounds of communication (and associated data exchanges) between the parties/computing systems in the MPC/2PC cluster. Moreover, unlike certain neural networks deployed in the MPC setup, the activation computations are not performed in plaintext, thus preserving the privacy of the underlying data at all points during training or inference of the neural network.

In summary, the above-described techniques demonstrate the computational resource efficiencies achieved by using cosine activation and Hadamard-Diagonal matrices to facilitate the computations performed during training or inference of neural networks in an MPC-based environment (in which data privacy is also maintained over the data received as input for the neural network as well as the data that is used as input for each successive layer of the neural network).

FIG. 2 is a flow diagram of an example process 200 for computing an output of a neural network layer in an MPC environment that preserves privacy over the input data used in the neural network computations. Operations of process 200 are described below as being performed by the components of the system described and depicted in FIG. 1. Operations of the process 200 are described below for illustration purposes only. Operations of the process 200 can be performed by any appropriate device or system, e.g., any appropriate data processing apparatus. Operations of the process 200 can also be implemented as instructions stored on a non-transitory computer readable medium. Execution of the instructions causes one or more data processing apparatus to perform operations of the process 200.

As described with reference to FIG. 1, the computation of the output of a particular layer of a neural network as deployed therein includes using a cosine activation function and further contemplates an MPC environment (as an example, a 2PC environment that uses two different computing systems, which are referred to as servers 104 and 108 in FIG. 1). The following described operations of process 200 are applicable in the context of neural network training as well as during inference when using the trained neural network. In both contexts, each server/computing system in the 2PC environment receives, from a separate computing system (such as, e.g., client device 102), separate, secret shares of input data for the neural network. In the training context, the input data includes features and labels of the training dataset, which are then provided by the client device 102 to each of the servers 104 and 108, as secret shares. Similarly, in the inference context, the input data includes data for a set of a features, which are then provided by the client device 102 to each of the servers 104 and 108, as secret shares. As one skilled in the art will appreciate, each secret share can be further encrypted using any appropriate encryption technique/algorithm and thus, the subsequently-described operations are performed on the encrypted secret shares. Moreover, as described with reference to FIG. 1, the client device 102 can use any appropriate data splitting technique to divide/split the input data into the respective secret shares that it then sends to the server 104 and server 108.

Turning to the operations of process 200, these operations are described as being performed by server 104 (although the same operations are also performed in parallel by server 108, given that each is operating on its received secret share of data).

Server 104 generates, based on the first data part, a cosine value and a sine value (at 210). In some implementations, and as described with reference to FIG. 1, the server 104 uses the received first data part (which is its secret share corresponding to the input data) to generate a cosine value and a sine value. For example, assuming the first data part received by server 104 is [x]₁, then server 104 can compute cos[x]₁ and sin[x]₁. Similarly, and in parallel, server 108 can compute cos[x]₂ and sin[x]₂ using its share (second data part) [x]₂.

Server 104 generates, for each of the cosine value and the sine value, a pair of additive secret shares (at 220). In some implementations, and as described with reference to FIG. 1, server 104 generates, using the cosine value, a first pair of secret share cosine values and further generates, using the sine value, a second pair of secret share sine values. For example, server 104 can use an additive secret share algorithm to generate, from cos[x]₁, [cos[x]₁]₁ and [cos[x]₁]₂ and generate, from sin[x]₁, [sin[x]₁]₁ and [sin[x]₁]₂. Similarly, and in parallel, server 108 generates, from cos[x]₂ and sin[x]₂, [cos[x]₂]₁, [cos[x]₂]₂, [sin[x]₂]₁ and [sin[x]₂]₂.

Server 104 transmits, to the second computing system (server 108), a first secret share from each pair of the additive secret shares (at 230). In some implementations, and as described with reference to FIG. 1, server 104 can transmit, to the server 108, a first secret share sine value selected from the first pair of secret share sine values and a first secret share cosine value selected from the first pair of secret share cosine values. For example, as described with reference to FIG. 1, server 104 can transmit [cos[x]₁]₂ and [sin[x]₁]₂ to server 108.

Server 104 receives, from the second computing system (server 108), a pair of secret shares that are generated by the second computing system using the second data part (as 240). In some implementations, and as described with reference to FIG. 1, the pair of secret shares that are generated by the server 108 using the second data part ([x]₂), includes a third secret share sine value and third secret share cosine value. For example, and as described with reference to FIG. 1, server 108 can transmit [cos[x]₂]₁ and [sin[x]₂]₁ to server 104.

Server 104 collaborates with the second computing system (server 108) to multiply, using a secure multiplication protocol, the pair of additive secret shares corresponding to the cosine value with a second pair of secret share cosine values, to obtain a first cosine product and a second cosine product (at 250). Similar to operation 250, the server 104 collaborates with the second computing system (server 108) to multiply, using the same secure multiplication protocol, the pair of additive secret shares corresponding to the cosine value with a second pair of secret share cosine values, to obtain a first cosine product and a second cosine product (at 260). Although described as two separate operations, one skilled in the art will understand that these operations can be performed as part of a single communication interaction between the servers 104 and 108. In some implementations, the secure multiplication protocol can include a Beaver Triplet protocol. Moreover, in some implementations, and as described with reference to FIG. 1, each of the servers 104 and 108 can collaborate use the secure multiplication protocol (e.g., Beaver Triplets) to compute a secure multiplication of both servers' cosine additive shares as well as a secure multiplication of both servers' sine additive shares. The resulting secure multiplication operations can be represented using the following equations (the reference below to Mult refers to the function that triggers the Beaver Triplets secure multiplication protocol):

[cos[x]₁ cos[x]₂]₁,[cos[x]₁ cos[x]₂]₂=Mult(([cos[x]₁]₁,[cos[x]₂]₁),([cos[x]₁]₂,[cos[x]₂]₂)

and

[sin[x]₁ sin[x]₂]₁,[sin[x]₁ sin[x]₂]₂=Mult(([sin[x]₁]₁,[sin[x]₂]₁),([sin[x]₁]₂,[sin[x]₂]₂)

Server 104 can store the first cosine product value and the first sine product value in a repository corresponding to the server 104. In some implementations, and upon completion of the secure multiplication (as described in the preceding operations 250, 260), server 104 stores the following cosine and sine product values (generated as part of the secure multiplication) in a repository or other data storage devices accessible to the server 104: ([cos[x]₁]₁, [cos[x]₂]₁) and ([sin[x]₁]₁, [sin[x]₂]₁). Similarly, server 108 stores the following second cosine and second sine product values (generated as part of the secure multiplication) in a repository or other data storage devices accessible to the server 108: ([cos[x]₁]₂, [cos[x]₂]₂) and ([sin[x]₁]₂, [sin[x]₂]₂).

Server 104 computes a first part of a cosine activation value based on the first cosine product and the first sine product (at 270). In some implementations, and as described with reference to FIG. 1, server 104 computes the first part of the cosine activation value by subtracting the first sine product value from the first cosine product value. For example, the computation of the first part of the cosine activation value can be represented using the following equation:

[Z]₁=[cos[x]₁ cos[x]₂]₁−[sin[x]₁ sin[x]₂]₁

Similarly, and as described with reference to FIG. 1, server 108 computes a second part of the cosine activation value by subtracting the second sine product value from the second cosine product value. For example, the computation of the second part of the cosine activation value can be represented using the following equation:

[Z]₂=[cos[x]₁ cos[x]₂]₂−[sin[x]₁ sin[x]₂]₂

Server 104 can provide the first part of the cosine activation value for further processing by another layer of the neural network or to a third computing device for computation of an overall output of the neural network (at 270). In some implementations, when the particular layer is not an output layer of the neural network, the server 104 provides the first part of the cosine activation value as input to a subsequent/successive layer in the neural network (e.g., neural network 112 corresponding to model 106). On the other hand, when the particular layer is the output layer of the neural network (e.g., neural network 112 corresponding to model 106), the server 104 provides the first part of the cosine activation value to a third computing device (e.g., client device 102) for computation of the overall output of the neural network. In implementations where the first part of the cosine activation value is provided as an input to a subsequent/successive layer of the neural network (and by extension, the second part of the cosine activation value is also provided as an input to a subsequently/success layer of its neural network), the above described operations (operations 210 to 270) are performed with respect to these new intermediate inputs. In fact, as one skilled in the art will appreciate, these operations are iteratively performed at each successive layer of the neural network, from the input layer to the output layer. In implementations where the particular layer of the neural network is the output layer, each of the servers 104 and 108 provide their respective share/part of the cosine activation value [Z]₁ and [Z]₂ (i.e., the first and second parts of the cosine activation values) to a third computing device (e.g., client device 102) that initially provided the input data. The client device 102 can combine these shares of the cosine activation values to compute the overall output of the neural network, which can be represented using the following equations (as also described in detail with reference to FIG. 1):

[Z]=[Z]₁+[Z]₂

[Z]=cos[x]₁ cos[x]₂−sin[x]₁ sin[x]₂

In some implementations, as part of the underlying linear transformation computations (multiplications of the weight matrix with the input data) for the computation of the first part of the cosine activation value, server 104 computes the linear transformations by structuring a weight matrix using Hadamard-Diagonal matrices (as further described with reference to FIG. 1). In some implementations, the Hadamard-Diagonal matrices include diagonal matrices with learnable weights and a normalized Walsh-Hadamard matrix of a predefined order, such that structuring the weight matrix using the Hadamard-Diagonal matrices comprises multiplying the diagonal matrices, with the normalized Walsh-Hadamard matrix (as further described with reference to FIG. 1).

In some implementations, the diagonal matrices with learnable weights can be represented as D∈R^{d*d} and the normalized Walsh-Hadamard matrix (H) has a predefined order of d and is defined recursively using the following equation (with k in the below being assumed to equal d)

$${H}_{{2}^{k}} = \frac{1}{{2}^{k / 2}} [ \begin{matrix}{H}_{{2}^{k - 1}} & {H}_{{2}^{k - 1}} \\ {H}_{{2}^{k - 1}} & - {H}_{{2}^{k - 1}}\end{matrix} ]$$

In this manner, the subject matter described in this specification contemplates utilizing cosine activation and Hadamard-Diagonal matrices for neural networks deployed in an MPC/2PC, to achieve the privacy preserving features of MPC/2PC setups as well as significant computational resource efficiencies in the performance of the underlying neural network operations (which generally are resource intensive in the context of known MPC/2PC setups).

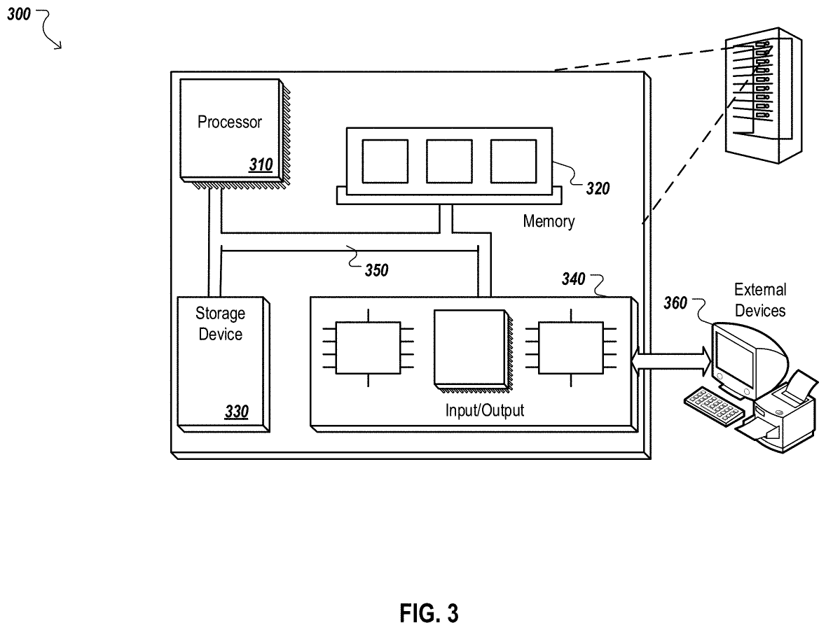

FIG. 3 is block diagram of an example computer system 300 that can be used to perform operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, a storage device that is shared over a network by multiple computing devices (e.g., a cloud storage device), or some other large capacity storage device.

The input/output device 340 provides input/output operations for the system 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 360. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for computing an output of a particular layer of a neural network deployed in a two computing system environment using a cosine activation function, wherein the output is computed for input data that is split into a first data part and a second data part, with the first data part being provided to a first computing system and a second part being provided to a second computing system, the method as implemented at the first computing system, comprises:
generating, based on the first data part, a cosine value and a sine value;
generating, for each of the cosine value and the sine value, a pair of additive secret shares;
transmitting, to the second computing system, a first secret share from each pair of the additive secret shares;
receiving, from the second computing system, a pair of secret shares that are generated by the second computing system using the second data part;
multiplying, using a secure multiplication protocol and in collaboration with the second computing system, (1) the pair of additive secret shares corresponding to the cosine value with a second pair of secret share cosine values, to obtain a first cosine product and a second cosine product, and (2) the pair of additive secret shares corresponding to the cosine value with a second pair of secret share sine values, to obtain a first sine product value and a second sine product value, wherein the second pair of secret share cosine values and the second pair of secret share sines values are computed by the second computing system; and
computing a first part of a cosine activation value based on the first cosine product and the first sine product; and
providing the first part of the cosine activation value for further processing by another layer of the neural network or to a third computing device for computation of an overall output of the neural network.

2. The computer-implemented method of claim 1, wherein generating, for each of the cosine value and the sine value, the pair of additive secret shares, comprises:
generating, using the cosine value, a first pair of secret share cosine values; and
generating, using the sine value, a second pair of secret share sine values.

3. The computer-implemented method of claim 2, wherein transmitting, to the second computing system, the first secret share from each pair of the additive secret shares, comprises:
transmitting, to the second computing system, a first secret share sine value selected from the first pair of secret share sine values; and
transmitting, to the second computing system, a first secret share cosine value selected from the first pair of secret share cosine values.

4. The computer-implemented method of claim 1, wherein the secure multiplication protocol comprises a Beaver Triplets protocol.

5. The computer-implemented method of claim 1, further comprising storing the first cosine product value and the first sine product value in a repository corresponding to the first computing system.

6. The computer-implemented method of claim 1, wherein computing the cosine activation is performed during training of the neural network and wherein the input data is training data for training the neural network, the first data part is a first part of the training data, and the second data part is a second part of the training data.

7. The computer-implemented method of claim 1, wherein providing the first part of the cosine activation value for further processing by another layer of the neural network or to the third computing device for computation of the overall output of the neural network, comprises:
when the particular layer is not an output layer of the neural network, providing the first part of the cosine activation value as input to a subsequent layer in the neural network; or
when the particular layer is the output layer of the neural network, providing the first part of the cosine activation value to the third computing device for computation of the overall output of the neural network.

8. The computer-implemented method of claim 1, wherein the pair of secret shares that are generated by the second computing system using the second data part, comprise a third secret share sine value and third secret share cosine value.

9. The computer-implemented method of claim 1, wherein computing the first part of the cosine activation value comprises:
structuring a weigh matrix using a Hadamard-Diagonal matrices, wherein
the Hadamard-Diagonal matrices comprise diagonal matrices with learnable weights and a normalized Walsh-Hadamard matrix of a predefined order d that is defined using the following equation:
$${H}_{{2}^{k}} = \frac{1}{{2}^{k / 2}} [ \begin{matrix}{H}_{{2}^{k - 1}} & {H}_{{2}^{k - 1}} \\ {H}_{{2}^{k - 1}} & - {H}_{{2}^{k - 1}}\end{matrix} ]$$
and
wherein structuring the weight matrix using the Hadamard-Diagonal matrices comprises multiplying the diagonal matrices with learnable weights, with the normalized Walsh-Hadamard matrix.

10. A first computing system, comprising:
at least one data processing apparatus;
at least one memory coupled to the at least one data processing apparatus, wherein the at least one memory stores programming instructions that when executed by the at least one data processing apparatus, causes the performance of operations for computing an output of a particular layer of a neural network deployed in a two computing system environment using a cosine activation function, wherein the output is computed for input data that is split into a first data part and a second data part, with the first data part being provided to the first computing system and a second part being provided to a second computing system, the operations comprising:
generating, based on the first data part, a cosine value and a sine value;
generating, for each of the cosine value and the sine value, a pair of additive secret shares;
transmitting, to the second computing system, a first secret share from each pair of the additive secret shares;
receiving, from the second computing system, a pair of secret shares that are generated by the second computing system using the second data part;
multiplying, using a secure multiplication protocol and in collaboration with the second computing system, (1) the pair of additive secret shares corresponding to the cosine value with a second pair of secret share cosine values, to obtain a first cosine product and a second cosine product, and (2) the pair of additive secret shares corresponding to the cosine value with a second pair of secret share sine values, to obtain a first sine product value and a second sine product value, wherein the second pair of secret share cosine values and the second pair of secret share sines values are computed by the second computing system; and
computing a first part of a cosine activation value based on the first cosine product and the first sine product; and
providing the first part of the cosine activation value for further processing by another layer of the neural network or to a third computing device for computation of an overall output of the neural network.

11. The system of claim 10, wherein generating, for each of the cosine value and the sine value, the pair of additive secret shares, comprises:
generating, using the cosine value, a first pair of secret share cosine values; and
generating, using the sine value, a second pair of secret share sine values.

12. The system of claim 11, wherein transmitting, to the second computing system, the first secret share from each pair of the additive secret shares, comprises:
transmitting, to the second computing system, a first secret share sine value selected from the first pair of secret share sine values; and
transmitting, to the second computing system, a first secret share cosine value selected from the first pair of secret share cosine values.

13. The system of claim 10, wherein the secure multiplication protocol comprises a Beaver Triplets protocol.

14. The system of claim 10, where computing the cosine activation is performed during training of the neural network and wherein the input data is training data for training the neural network, the first data part is a first part of the training data, and the second data part is a second part of the training data.

15. The system of claim 10, wherein providing the first part of the cosine activation value for further processing by another layer of the neural network or to the third computing device for computation of the overall output of the neural network, comprises:
when the particular layer is not an output layer of the neural network, providing the first part of the cosine activation value as input to a subsequent layer in the neural network; or
when the particular layer is the output layer of the neural network, providing the first part of the cosine activation value to the third computing device for computation of the overall output of the neural network.

16. The system of claim 1, wherein the pair of secret shares that are generated by the second computing system using the second data part, comprise a third secret share sine value and third secret share cosine value.

17. The system of claim 10, wherein computing the first part of the cosine activation value comprises:
structuring a weigh matrix using a Hadamard-Diagonal matrices, wherein the Hadamard-Diagonal matrices comprise diagonal matrices with learnable weights and a normalized Walsh-Hadamard matrix of a predefined order and wherein structuring the weight matrix using the Hadamard-Diagonal matrices comprises multiplying the diagonal matrices with learnable weights, with the normalized Walsh-Hadamard matrix.

18. The computer-implemented method of claim 8, wherein the diagonal matrices with learnable weights are represented as D∈R^{d*d} and the normalized Walsh-Hadamard matrix (H) has a predefined order of d and is defined recursively using the following equation
$${H}_{{2}^{k}} = \frac{1}{{2}^{k / 2}} [ \begin{matrix}{H}_{{2}^{k - 1}} & {H}_{{2}^{k - 1}} \\ {H}_{{2}^{k - 1}} & - {H}_{{2}^{k - 1}}\end{matrix} ]$$
where k is equal to d.

19. A non-transitory computer readable medium storing instructions that, when executed by one or more data processing apparatus corresponding to a first computing system, cause the one or more data processing apparatus to perform operations for computing an output of a particular layer of a neural network deployed in a two computing system environment using a cosine activation function, wherein the output is computed for input data that is split into a first data part and a second data part, with the first data part being provided to the first computing system and a second part being provided to a second computing system, the operations comprising:
generating, based on the first data part, a cosine value and a sine value;
generating, for each of the cosine value and the sine value, a pair of additive secret shares;
transmitting, to the second computing system, a first secret share from each pair of the additive secret shares;
receiving, from the second computing system, a pair of secret shares that are generated by the second computing system using the second data part;
multiplying, using a secure multiplication protocol and in collaboration with the second computing system, (1) the pair of additive secret shares corresponding to the cosine value with a second pair of secret share cosine values, to obtain a first cosine product and a second cosine product, and (2) the pair of additive secret shares corresponding to the cosine value with a second pair of secret share sine values, to obtain a first sine product value and a second sine product value, wherein the second pair of secret share cosine values and the second pair of secret share sines values are computed by the second computing system; and
computing a first part of a cosine activation value based on the first cosine product and the first sine product; and
providing the first part of the cosine activation value for further processing by another layer of the neural network or to a third computing device for computation of an overall output of the neural network.

20. A computer-implemented method for securely computing an output of a neural network, comprising:
splitting, by a client device, input data into a first secret share and a second secret share, wherein the input data comprises data for a set of features;
transmitting, by the client device, the first secret share to a first computing system and the second secret share to a second computing system;
obtaining, by the client device, from the first computing system, and in response to transmitting the first secret share, a first part of a cosine activation value;
obtaining, by the client device, from the second computing system, and in response to transmitting the second secret share, a second part of a cosine activation value;
combining the first part of the cosine activation value and the second part of the cosine activation value to compute the output of the neural network.
